(19) United States
(12) Patent Application Publication
(10) Pub. No.: US 2012/0169617 A1
(43) Pub. Date: Jul. 5, 2012

(54) CONTROLLING OF USER INPUT DEVICE

(75) Inventor: Jani C. Mäenpää, Espoo (FI)

(73) Assignee: NOKIA CORPORATION, Espoo (FI)

(21) Appl. No.: 12/984,202

(22) Filed: Jan. 4, 2011

(51) Int. Cl. G06F 3/041

(52) U.S. Cl. 345/173

(57) ABSTRACT

Locking or unlocking of a user input of a portable device is detected from the way in which a user has stroked her finger on a touch screen. The stroke is checked for two different determinations which require that the touch screen is touched according to a predetermined track and with a force pattern that has at least one substantial change so as to avoid the need to provide the apparatus with any mechanical buttons at all while providing user-reproducible indication of locking or unlocking of the user input with the touch screen.

### TECHNICAL FIELD

The present invention generally relates to controlling of a user input device. The present invention relates in particular, though not exclusively, to locking of a user input device of a portable device.

### BACKGROUND ART

User input devices are used to enter data and/or commands. Sometimes, it is desired to temporarily prevent such entering. Such temporary preventing is often referred to as a key lock that is provided by many currently available mobile phones, for example. However, a touch screen based devices are not compatible with the most traditional key locks where two keys are pressed in a predetermined order. Thus, a separate key lock switch is provided in some touch screen based mobile phones solely for the purpose of unlocking the user input. In some other touch screen based phones, the user input may be opened by pressing a button and then striking a finger across the bottom of the touch screen.

### SUMMARY

According to a first example aspect of the invention there is provided an apparatus comprising:
a touch screen configured to display information and to output a touch position signal indicative of the position where the touch screen has been touched by a user;
a touch pressing force sensor configured to output a force signal indicative of the force with which the touch screen is pressed by the user while touching the touch screen; and
at least one processor configured to receive the touch position signal and the force signal and to detect the presence of following determinations:
the touch position signal indicates that the user has stroked on the touch screen according to a predetermined track; and

b) the force signal indicates that the user has applied on the touch screen a force according to a predetermined pattern, which pattern contains at least one change that exceeds a predetermined threshold.

The at least one processor may further be configured to allow user input in response to said detecting of said determinations.

The predetermined track may be a linear track. The linear track may extend across the touch screen at least to a predetermined extent.

The predetermined track may be a curve. The curve may be a circle, ellipsoid, meandering curve such as sinusoidal curve, or at least a part thereof.

The predetermined pattern may comprise a first force threshold, a second force threshold and a third force threshold, wherein both the first and third force thresholds are greater or smaller than the second force threshold. The pattern may further comprise a condition that the force extends over the first force threshold to the second force threshold and then to the third force threshold. The pattern may further comprise a condition that the force stays above a predetermined fourth force threshold.

The first force threshold comprise a first minimum force threshold, the second force threshold may comprise a first maximum force threshold, and the third force threshold may comprise a second minimum force threshold, wherein the first and second minimum force thresholds exceed the first maximum force threshold. The first and third force thresholds may further comprise respective minimum force threshold and the second force threshold may further comprise a maximum force threshold so that the first, second and third force thresholds together define an envelope within which the force indicated by the force signal may vary while the determination is met that the force signal indicates that the user has applied on the touch screen a force according to a predetermined pattern, which pattern contains at least one change that exceeds a predetermined threshold.

Alternatively, the first force threshold comprise a first maximum force threshold, the second force threshold may comprise a first minimum force threshold, and the third force threshold may comprise a second maximum force threshold, wherein the first and second maximum force thresholds fall below the first minimum force threshold. The first and third force thresholds may further comprise respective maximum force threshold and the second force threshold may further comprise a minimum force threshold so that the first, second and third force thresholds together define an envelope within which the force indicated by the force signal may vary while the determination is met that the force signal indicates that the user has applied on the touch screen a force according to a predetermined pattern, which pattern contains at least one change that exceeds a predetermined threshold.

According to a second example aspect of the invention there is provided a method comprising:
displaying information on a touch screen;
outputting a touch position signal indicative of the position where the touch screen has been touched by a user;
outputting a force signal indicative of the force with which the touch screen is pressed by the user while touching the touch screen; and
detecting the presence of following determinations:
   the touch position signal indicates that the user has stroked on the touch screen according to a predetermined track; and
   the force signal indicates that the user has applied on the touch screen a force according to a predetermined pattern, which pattern contains at least one change that exceeds a predetermined threshold.

According to a third example aspect of the invention there is provided a computer program comprising computer executable program code which when executed by at least one processor causes an apparatus at least to perform:
displaying information on a touch screen;
outputting a touch position signal indicative of the position where the touch screen has been touched by a user;
outputting a force signal indicative of the force with which the touch screen is pressed by the user while touching the touch screen; and
detecting the presence of following determinations:
   the touch position signal indicates that the user has stroked on the touch screen according to a predetermined track; and
   the force signal indicates that the user has applied on the touch screen a force according to a predetermined pattern, which pattern contains at least one change that exceeds a predetermined threshold.

According to a fourth example aspect of the invention there is provided a computer program product comprising a non-transitory computer readable medium having the computer program of the third example aspect stored thereon.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

Some example embodiments of the invention will be described with reference to the accompanying drawings, in which:

FIG. 1 shows a schematic picture of a system according to an example embodiment of the invention;

FIG. 2 presents a chart illustrative of force and motion expected according to one example embodiment of the invention for a positive determination; and

FIG. 3 presents a process according to an example embodiment of the invention.

### DETAILED DESCRIPTION

In the following description, like reference signs denote like elements.

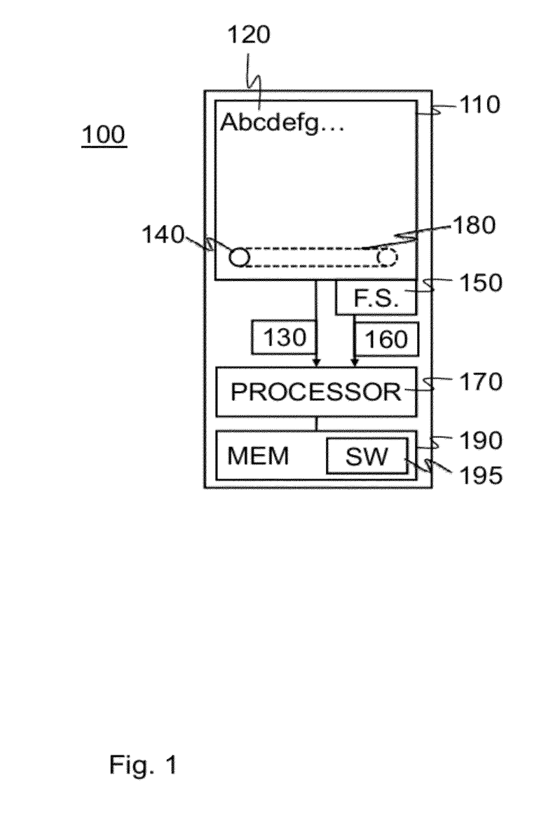

FIG. 1 shows a schematic picture of an apparatus 100 according to a first example embodiment of the invention. The apparatus 100 comprises a touch screen 110 configured to display information 120 and to output a touch position signal 130 indicative of the position 140 where the touch screen 110 has been touched by a user. The apparatus 100 further comprises a touch pressing force sensor 150 configured to output a force signal 160 indicative of the force with which the touch screen 110 is pressed by the user while touching the touch screen 110. The apparatus 100 further comprises at least one processor 170 configured to receive the touch position signal 130 and the force signal 160 and to detect the presence of following determinations:

a) the touch position signal 130 indicates that the user has stroked on the touch screen according to a predetermined track 180; and

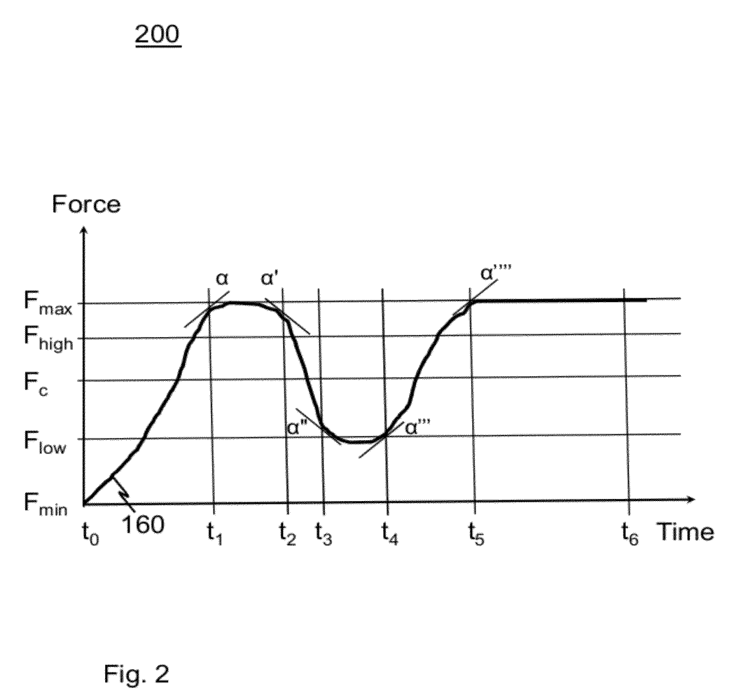

b) the force signal 160 indicates that the user has applied on the touch screen 110 a force according to a predetermined pattern 200 (FIG. 2), which pattern contains at least one change 210 (FIG. 2) that exceeds a predetermined threshold 220 (FIG. 2).

In a second example embodiment that is optionally applicable in conjunction with the first example embodiment, the apparatus 100 further comprises a memory 190 that comprises computer executable software or (e.g. a program) 195 that comprises program code configured to cause the processor 180 to control different operations of the apparatus 100.

In a third example embodiment that is optionally applicable in conjunction with any or all of the first and second example embodiment, the at least one processor is further configured to allow user input in response to the detecting of the determinations a) and b). This way, a user can unlock the user input for controlling the apparatus 100.

In a fourth example embodiment that is optionally applicable in conjunction with any or all of the first to third example embodiment, when the user input of the apparatus 100 is already unlocked, the determinations a) and b) cause the at least one processor 170 to lock the user input.

The determinations a) and b), as also illustrated by FIG. 2, enable a user to indicate the desire to lock or unlock the user input simply by swiping a finger or other object on the touch screen 110 along a given track. To avoid accidental locking or unlocking, also a force pattern is applied to verify that the swiping action indeed comes from a user intending to lock or unlock the apparatus 100. Moreover, many applications also require swiping on the touch screen 110 along the predetermined track 180 and it is advantageous to avoid interpreting such swiping as a command to lock or unlock the user input.

In a fifth example embodiment that is optionally applicable in conjunction with any or all of the first to fourth example embodiment, the force sensor 150 comprises one or more force sensing elements in addition to the touch screen 110. Such force sensing elements comprise, for instance, piezo-electric stress strips. The force sensing elements may reside, for instance, behind the touch screen 110 and/or within or behind a rear cover (not shown) of the apparatus 100.

In a sixth example embodiment that is optionally applicable in conjunction with any or all of the first to fourth example embodiment, the touch screen 110 itself is capable of indicating the force with which the surface of the touch screen 110 is pressed by the user, in which case the touch screen 110 produces both the touch position signal 130 and the force signal 160.

In a seventh example embodiment that is optionally applicable in conjunction with any or all of the first to sixth example embodiment, the predetermined track 180 is a linear track. The linear track may extend across the touch screen at least to a predetermined extent.

In an eighth example embodiment that is optionally applicable in conjunction with any or all of the first to sixth example embodiment, the predetermined track 180 is a curve. The curve may be a circle, ellipsoid, meandering curve such as sinusoidal curve, or at least a part thereof.

In a ninth example embodiment that is optionally applicable in conjunction with any or all of the first to eighth example embodiment, the predetermined pattern comprises a first force threshold, a second force threshold and a third force threshold, wherein both the first and third force thresholds are greater or smaller than the second force threshold. In a tenth example embodiment that is optionally applicable in conjunction with the ninth example embodiment, the pattern further comprises a condition that the force extends over the first force threshold to the second force threshold and then to the third force threshold. In an eleventh example embodiment that is optionally applicable in conjunction with any or both of the ninth or tenth example embodiment, the pattern further comprises a condition that the force stays above a predetermined fourth force threshold.

In a twelfth example embodiment that is optionally applicable in conjunction with any or all of the first to eighth example embodiment, the first force threshold comprises a first minimum force threshold. The second force threshold may comprise a first maximum force threshold. The third force threshold may comprise a second minimum force threshold. The first and second minimum force thresholds may exceed the first maximum force threshold.

In a thirteenth example embodiment that is applicable in conjunction with the twelfth example embodiment, the first and third force thresholds further comprise respective minimum force threshold and the second force threshold further comprises a maximum force threshold so that the first, second and third force thresholds together define an envelope within which the force indicated by the force signal 160 may vary while the condition b) is met.

In a fourteenth example embodiment that is optionally applicable in conjunction with any or all of the first to eighth example embodiment, the first force threshold comprises a first maximum force threshold, the second force threshold comprises a first minimum force threshold, and the third force threshold comprises a second maximum force threshold, wherein the first and second maximum force thresholds fall below the first minimum force threshold.

In a fifteenth example embodiment that is applicable in conjunction with the fourteenth example embodiment, the first and third force thresholds further comprise respective maximum force threshold and the second force threshold may further comprise a minimum force threshold so that the first, second and third force thresholds together define an envelope within which the force indicated by the force signal 160 may vary while the condition b) is met.

In other words, the predetermined pattern may define user-reproducible changes in the force over a relatively short period of time. By user-reproducibly it is meant that the necessitated difference in force is that large that a user has no difficulty in making such a distinction time after time.

FIG. 2 presents a chart illustrative of force and motion expected for a positive determination, according to a sixteenth example embodiment that is optionally applicable in conjunction with any or all of the first to fifteenth example embodiment. The chart presents the force signal 160 measured by the force sensor 150 against time. In order to simplify this description, the force signal 160 is understood as if it were the touch force rather than an indication thereof.

The force signal 160 starts at zero time and force (time t₀ and force Fₘᵢₙ). The force signal 160 then climbs over a low force threshold F_{low}, over a central force threshold F_{c} and over a high force threshold F_{high} until the force signal 160 reaches a maximum force Fₘₐₓ that the force sensor 150 can output. The maximum force is reached slightly after a first moment of time t₁, which moment is indicative of beginning of a first high force part. The first moment of time is defined as a moment when the force signal 160 meets a first criterion. The meeting of the first criterion is determined, according to a seventeenth example embodiment that is optionally applicable in conjunction with any or all of the first to sixteenth example embodiment, in a ways selected from a group consisting of:

a) the force signal 160 exceeds the central force threshold F_{c};

b) the force signal 160 exceeds the high force threshold F_{high};

c) the force signal 160 reaches the maximum force Fₘₐₓ; and

d) the angle of the force signal 160 measured (e.g. determined as a first derivative of the force) decreases below a first threshold angle α, such as 60 degrees, 45 degrees or 30 degrees. Optionally, this determination may also require that a given one of the preceding criteria a) or c) is also met.

The force signal 160 then stays at very high level, nearing the maximum force Fₘₐₓ and then starts to decline. A second moment of time T₂ is determined indicative of the moment where the force signal 160 begins a significant change such as a dip drawn in FIG. 2. The second moment of time is defined as a moment when the force signal 160 meets a second criterion. The second criterion is in, an eighteenth example embodiment that is optionally applicable in conjunction with any or all of the first to seventeenth example embodiment, selected from a group consisting of:

e) the force signal 160 falls below the high force threshold F_{high};

f) the force signal 160 falls below the central force threshold F_{c}; and

g) the angle of the force signal 160 measured (e.g. determined as a first derivative of the force) decreases below a second threshold angle α′, such as −60 degrees, −45 degrees or −30 degrees. Optionally, this determination may also require that a given one of the preceding criteria e) or f) is also met.

The force signal 160 reaches substantially the end of a substantial change in the touching at a third moment of time T₃, that is, the force signal reaches the bottom of the force dip in FIG. 2. The third moment of time T₃ is defined as the moment when the force signal 160 meets a third criterion. In a nineteenth example embodiment that is optionally applicable in conjunction with any or all of the first to eighteenth example embodiment, the third criterion is selected from a group consisting of:

e) the force signal 160 falls below the low force threshold F_{low};

f) the force signal 160 falls below the central force threshold F_{c}; and

g) the angle of the force signal 160 measured (e.g. determined as a first derivative of the force) reaches a third threshold angle α″, such as −60 degrees, −45 degrees or −30 degrees. The third threshold angle may equal to the second threshold angle α′ or there may be a hysteresis or intentional difference between the third threshold angle α″ and the second threshold angle α′ so as to avoid accidental too early determination of the third moment of time. Alternatively or additionally, this determination may also require that a given one of the preceding criteria e) or f) is also met.

The force signal 160 stays for a short while at the end of the substantial change until a fourth moment of time T₄, that is, the force signal reaches the bottom of the force dip in FIG. 2. The fourth moment of time T₄ is defined as the moment when the force signal 160 meets a fourth criterion. In a twentieth example embodiment that is optionally applicable in conjunction with any or all of the first to seventeenth example embodiment, the fourth criterion is selected from a group consisting of:

h) the force signal 160 exceeds the high force threshold F_{low};

i) the angle of the force signal 160 measured (e.g. determined as a first derivative of the force) exceeds a fourth threshold angle α′″, such as 60 degrees, 45 degrees or 30 degrees. The fourth threshold angle α′″ may equal to the first threshold angle α. Optionally, this determination may also require that the criterion h) is also met.

The force signal 160 then starts to resume substantially to where it was before the substantial change towards a fifth moment of time T₅, that is, the force signal climbs substantially back to the maximum force Fₘₐₓ in FIG. 2. The fifth moment of time T₅ is defined as the moment when the force signal 160 meets a fifth criterion. In a twenty-first example embodiment that is optionally applicable in conjunction with any or all of the first to twentieth example embodiment, the fifth criterion is selected from a group consisting of:

a) the force signal 160 exceeds the central force threshold F_{c};

b) the force signal 160 exceeds the high force threshold F_{high};

c) the force signal 160 reaches the maximum force Fₘₐₓ; and

d′) the angle of the force signal 160 measured (e.g. determined as a first derivative of the force) decreases below a fifth threshold angle α″″, such as 60 degrees, 45 degrees or 30 degrees. This criterion d′) may correspond to the criterion d). The fifth threshold angle α″″ may equal to the first threshold angle α′ or to the third threshold angle α″. Optionally, this determination may also require that a given one of the preceding criteria a), b), c) or d′) is also met.

Then, the force signal 160 stays at a high level, or in FIG. 2, substantially at the maximum force Fₘₐₓ until a sixth moment of time T₆.

In FIG. 2, the force signal 160 was plotted against time. It is appreciated that the graph can also be perceived as plotted against distance along the track of a stroke along the touch screen 110. Correspondingly, the various criteria set out with reference to FIG. 2 would be computed as a function of propagation along the determined track.

Moreover, it shall be appreciated that the scale of FIG. 2 may exaggerate the initial climb and the dip durations in sake of illustration. Further still, FIG. 2 shows a dip in a force curve that indicates a start of a striking that signifies the command to lock or unlock the user input. However, as explained in the foregoing, instead of a dip, a bump i.e. temporary force increment is used in a twenty-second example embodiment that is optionally applicable in conjunction with any or all of the first to twenty-first example embodiment. Yet further, the force distinction need not necessarily be expected in the beginning of the striking. In a twenty-third example embodiment that is optionally applicable in conjunction with any or all of the first to twenty-second example embodiment, the force indication may be given at the tail of the striking or between the start and end points. In a twenty-fourth example embodiment that is optionally applicable in conjunction with any or all of the first to twenty-third example embodiment, the timing or position of the force indication is not specified at all i.e. there are no criteria other than that the force indication is given on striking the touch screen.

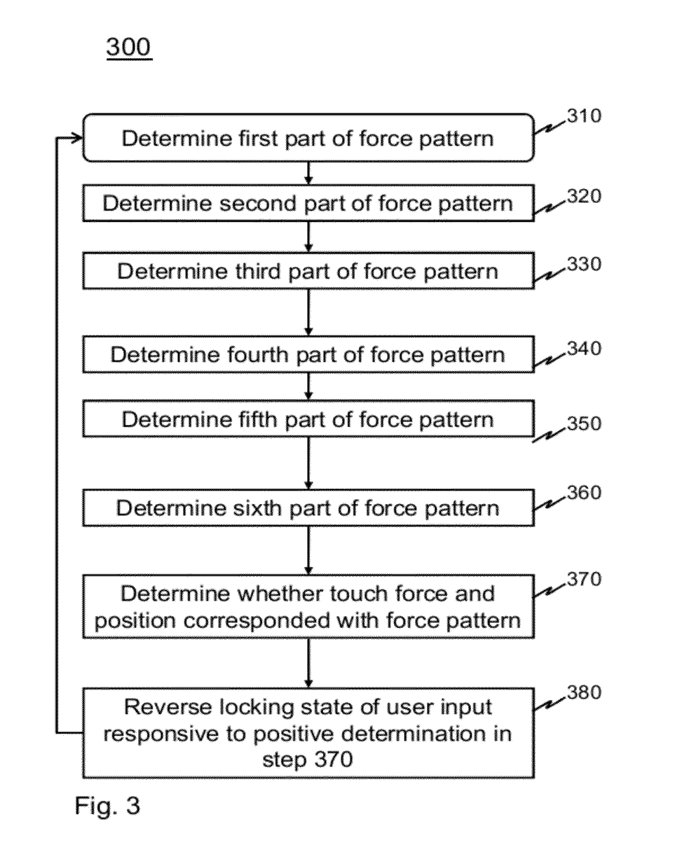

FIG. 3 presents a process according to a twenty-fifth example embodiment that is optionally applicable in conjunction with any or all of the first to twenty-fourth example embodiment, with the exception that the conditions for the timing or position of the force indication will be different or absent when applied with the twenty-third or twenty-fourth example embodiment.

In step 310, the first part of the force pattern is determined so that the first criterion is met. In a twenty-sixth example embodiment that is optionally applicable in conjunction with any or all of the first to twenty-fifth example embodiment, there is a further criterion that the criterion must be met during, for example within a time that is, for example, less than 0.5 seconds, less than 0.2 seconds, and/or more than 0.05 or 0.1 seconds.

In step 320, a second part of the force pattern is determined as the period between meeting the first and second criteria. In a twenty-seventh example embodiment that is optionally applicable in conjunction with any or all of the first to twenty-sixth example embodiment, this second part is subjected to a minimum and/or maximum duration such as 0.1 to 0.5 seconds and 0.5 to 2 seconds, respectively.

In step 330, a third part of the force pattern is determined as the period between meeting the second and third criteria. In a twenty-eighth example embodiment that is optionally applicable in conjunction with any or all of the first to twenty-seventh example embodiment, there is a further criterion that the transition from the meeting of the second to the meeting of the third criterion must be met during within a time that is, for example, less than 0.5 seconds, less than 0.2 seconds, and/or more than 0.05 or 0.1 seconds.

In step 340, a fourth part of the force pattern is determined as the period between meeting the third and fourth criteria. In a twenty-ninth example embodiment that is optionally applicable in conjunction with any or all of the first to twenty-eighth example embodiment, this fourth part is rather short so that the entire force pattern could be swiftly produced by the user; for instance, a time of 0.05 to 0.5 seconds is a range that is required in one example embodiment for determining the presence of the fourth part.

In step 350, a fifth part of the force pattern is determined as a period between meeting the fourth and fifth criteria. In a thirtieth seventh example embodiment that is optionally applicable in conjunction with any or all of the first to twenty-ninth example embodiment, this fifth part is also rather short so that the entire force pattern could be swiftly produced by the user; for instance, a time of 0.05 to 0.5 seconds is an example of a range that is required for determining the presence of the fifth part.

In step 360, a sixth part of the force pattern is determined as a period between meeting the fourth and fifth criteria. In a thirty-first example embodiment that is optionally applicable in conjunction with any or all of the first to thirtieth example embodiment, this sixth part is relatively long, especially in distance; for instance, a time of 0.2 to 2 seconds is an example range that is required for determining the presence of the sixth part. At this stage, there are no time criteria according to a thirty-second example embodiment that is optionally applicable in conjunction with any or all of the first to thirty-first example embodiment, but instead it is determined whether the touching proceeds along the predetermined track 180 to a given extent.

In step 370, it is determined whether the force signal 160 and the touch position signal have indicated that the user has stroked on the touch screen according to a predetermined track and so that the user has applied on the touch screen a force according to a predetermined pattern, which pattern contains at least one change that exceeds a predetermined threshold. If yes, the locking state of the user input is reversed in step 380 according to in one example embodiment.

It is appreciated that especially mobile smart phones with touch screens benefit from a simple and reliable locking and unlocking of the user input. This is particularly due to the fact that a user very easily touches the touch screen on pocketing the phone or taking it out of a pocket, and smart phones' touch screens are often littered with various icons that launch different applications and services. Unintentionally started data connection or satellite navigation application may draw significant amount of power so that remaining operating time may diminish surprisingly and thus impair user experience. By making the two different determinations a) and b) for a simple gesture it may also be possible to entirely avoid the need to provide the apparatus with any mechanical buttons at all, which translates into simplified and more robust structure and reduced costs.

In a thirty-third example embodiment that is optionally applicable in conjunction with any or all of the first to thirty-second example embodiment, a shortcut to a given user command is associated with a distinctive stroking on the touch screen 110. For instance, the stroking suited for meeting the determinations a) and b) may be supplemented by one or more further gestures made by the user. In response to such a supplemented stroking, the apparatus 100 recognises the user command and invokes corresponding action. In a thirty-fourth example embodiment that is applicable in conjunction with the thirty-third example embodiment, the supplementary gestures are, for instance, tapping the touch screen 110 and/or momentarily lifting a finger from the touch screen. The action invoked is such as invoking a radio transmitter (e.g. FM radio transmitter for connecting the apparatus to a car radio) in the apparatus 100, invoking a speech dialling function, invoking a music player or muting the apparatus or releasing muting of the apparatus, for example.

The foregoing description has provided by way of non-limiting examples of particular implementations and embodiments of the invention a full and informative description of the best mode presently contemplated by the inventors for carrying out the invention. For instance, the user may select the track along which the stroking is expected and/or the expected speed at which the stroking is expected. Moreover, depending on the technique with which the force of the touching is detected, there is a varying amount of noise and fast fluctuation in the force signal 160. To this end, appropriate filtering of the force signal 160 may be implemented. It is however clear to a person skilled in the art that the invention is not restricted to details of the embodiments presented above, but that it can be implemented in other embodiments using equivalent means or in different combinations of embodiments without deviating from the characteristics of the invention. Moreover, the appended abstract is incorporated into this description as one example embodiment of the invention that may optionally be combined with any embodiment of the invention presented in this patent application.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

I claim:

1. An apparatus comprising:
a touch screen configured to display information and to output a touch position signal indicative of the position where the touch screen has been touched by a user;
a touch pressing force sensor configured to output a force signal indicative of the force with which the touch screen is pressed by the user while touching the touch screen; and
at least one processor configured to receive the touch position signal and the force signal and to detect the presence of following determinations:
the touch position signal indicates that the user has stroked on the touch screen according to a predetermined track; and
the force signal indicates that the user has applied on the touch screen a force according to a predetermined pattern, which pattern contains at least one change that exceeds a predetermined threshold.

2. The apparatus of claim 1, wherein the at least one processor is further configured to unlock user input in response to said detecting of said determinations.

3. The apparatus of claim 1, wherein the predetermined track is a linear track.

4. The apparatus of claim 1, wherein the predetermined track is a curve.

5. The apparatus of claim 1, wherein the predetermined pattern comprises a first force threshold, a second force threshold and a third force threshold, wherein both the first and third force thresholds are greater or smaller than the second force threshold.

6. The apparatus of claim 5, wherein the predetermined pattern further comprises a condition that the force extends over the first force threshold to the second force threshold and then to the third force threshold.

7. The apparatus of claim 5, wherein the pattern further comprises a condition that the force stays above a predetermined fourth force threshold.

8. The apparatus of claim 6, wherein the pattern further comprises a condition that the force stays above a predetermined fourth force threshold.

9. The apparatus of claim 1, wherein the first force threshold comprises a first minimum force threshold, the second force threshold comprises a first maximum force threshold, and the third force threshold comprises a second minimum force threshold, wherein the first and second minimum force thresholds exceed the first maximum force threshold.

10. The apparatus of claim 1, wherein the first and third force thresholds further comprise respective minimum force threshold and the second force threshold further comprises a maximum force threshold so that the first, second and third force thresholds together define an envelope within which the force indicated by the force signal may vary while the determination is met that the force signal indicates that the user has applied on the touch screen a force according to a predetermined pattern, which pattern contains at least one change that exceeds a predetermined threshold.

11. The apparatus of claim 1, wherein the first force threshold comprises a first maximum force threshold, the second force threshold comprises a first minimum force threshold, and the third force threshold comprises a second maximum force threshold, wherein the first and second maximum force thresholds fall below the first minimum force threshold.

12. The apparatus of claim 1, wherein the first and third force thresholds further comprise respective maximum force threshold and the second force threshold further comprises a minimum force threshold so that the first, second and third force thresholds together define an envelope within which the force indicated by the force signal may vary while the determination is met that the force signal indicates that the user has applied on the touch screen a force according to a predetermined pattern, which pattern contains at least one change that exceeds a predetermined threshold.

13. A method comprising:
displaying information on a touch screen;
outputting a touch position signal indicative of the position where the touch screen has been touched by a user;
outputting a force signal indicative of the force with which the touch screen is pressed by the user while touching the touch screen; and
detecting the presence of following determinations:
the touch position signal indicates that the user has stroked on the touch screen according to a predetermined track; and
the force signal indicates that the user has applied on the touch screen a force according to a predetermined pattern, which pattern contains at least one change that exceeds a predetermined threshold.

14. The method of claim 13, further comprising unlocking user input in response to said detecting of said determinations.

15. The method of claim 13, wherein the predetermined track is a linear track.

16. The method of claim 13, wherein the predetermined track is a curve.

17. The method of claim 13, wherein the predetermined pattern comprises a first force threshold, a second force threshold and a third force threshold, wherein both the first and third force thresholds are greater or smaller than the second force threshold.

18. The method of claim 17, wherein the predetermined pattern further comprises a condition that the force extends over the first force threshold to the second force threshold and then to the third force threshold.

19. The method of claim 17, wherein the pattern further comprises a condition that the force stays above a predetermined fourth force threshold.

20. A computer program product comprising a non-transitory computer readable medium having a computer program stored thereon, the computer program comprising computer executable program code which when executed by at least one processor causes an apparatus at least to perform:
displaying information on a touch screen;
outputting a touch position signal indicative of the position where the touch screen has been touched by a user;
outputting a force signal indicative of the force with which the touch screen is pressed by the user while touching the touch screen; and
detecting the presence of following determinations:
the touch position signal indicates that the user has stroked on the touch screen according to a predetermined track; and
the force signal indicates that the user has applied on the touch screen a force according to a predetermined pattern, which pattern contains at least one change that exceeds a predetermined threshold.
